(19) United States
(12) Patent Application Publication
(10) Pub. No.: US 2003/0037340 A1
(43) Pub. Date: Feb. 20, 2003

(54) Method and apparatus for managing TV broadcast content that has synchronized web applications

(75) Inventors: Kavitha Vallari Devara, Ossining, NY (US); Jin Lu, Croton On Hudson, NY (US)

Correspondence Address: c/o Philips Electronics North America Corporation, Corporate Intellectual Property, 580 White Plains Road, Tarrytown, NY, 10591, US

(73) Assignee: Koninklijke Philips Electronics N.V.

(21) Appl. No.: 09/932,103

(22) Filed: Aug. 17, 2001

(51) Int. Cl. H04N 7/173; H04N 5/445

(52) U.S. Cl. 725/110; 725/134; 725/37; 725/39

(57) ABSTRACT

Disclosed is a method and system for managing television programs and their related web simulcasts. Accordingly, the present invention monitors incoming television signals to detect tag information, which identifies the source of the web simulcasts. Thereafter, a number of enhanced web contents is retrieved for storage in a memory medium for subsequent retrieval. The retrieved web contents are formatted according to predetermined criteria so that the TV viewer can participate selectively in one of the enhanced features linked to a particular television program and is of interest to the viewer.

### BACKGROUND OF THE INVENTION

1. Field of the Invention

The present invention relates to a personal video receiver, in particular, to a method and apparatus for managing television broadcasts having corresponding enhanced TV Web simulcasts.

2. Description of the Related Art

The modern world with huge amounts of multimedia gives television viewers a tremendous variety and range of options. Currently, there are over 500 different program channels shown through a cable television service. On-line Internet services also offer a variety of different services to consumers, including electronic news, private message services, games, and other related downloadable services. One form of electronic information known as “enhanced TV” is becoming very popular. For simplicity, the term “enhanced TV” or “enhanced feature” will refer to the web content provided by a broadcaster's server to allow viewers participation in various interactive features as they watch a TV program. In this feature, the content of a particular web page is synchronized with a television broadcast, so that a viewer can, via a personal receiver, log into a particular web-site at the same time the corresponding TV program is being broadcast. For example, web pages from the ABC.COM website related to Monday Night Football are active during the broadcast of “ABC's Monday Night Football.” During the football game, the ABC.COM site allows all users browsing the content of “Monday Night Football Enhanced TV pages” to guess what type of play the offense might run in the next play. These guesses from the viewers are collected until the next play is initiated; then, once the play is completed, responses are tallied and scores are updated. Other forms of inter-activities are also available within the same television program.

The trend now is that most TV broadcasters provide a variety of enhancement features for their viewers. A standard has been formed in this field by Advanced Television Systems Committee (ATSC) to deliver data broadcast applications over the digital Transport stream. The ATSC Data Broadcast Standard 2000 (A/90) provides a variety of applications to be sent in the broadcast stream and executed on a digital television (DTV) receiver or a set-top box (STB), the content of which is hereby incorporated by reference. However, the “enhanced features” linked to the television program are not typically known to the viewers in advance. Accordingly, it is foreseeable that there is a need to provide a management mechanism to assist the viewer in controlling a synchronized replay of both the TV broadcast and the corresponding, enhanced TV web simulcasts according to the viewer's preference. Therefore, the present invention provides a system and method through which different “enhanced features” may be downloaded in advance for a particular web-site and executed later, so that the viewer can selectively choose one of the enhancement features in which he or she likes to participate along with the television program.

### SUMMARY OF THE INVENTION

The present invention is directed to a method and system for managing television programs and their related web simulcasts.

According to an aspect of the invention, there is provided a management system, which includes a detection means, coupled to receive incoming television programs viewed by a user, for detecting tag information indicating the source of synchronized web simulcasts; a communication means for establishing a communication channel to the source of the synchronized web simulcasts; a storage means for storing data representative of a plurality of enhanced features corresponding to the incoming television programs; a controlling means, coupled to the storage means, the detection means, and the communication means, for retrieving the plurality of the enhanced features from the source of the synchronized web simulcasts and for formatting said retrieved enhanced features according to predetermined criteria to generate a content list selectable by the user; and, a display means, coupled to the controlling means, for displaying the incoming television programs and one of the retrieved enhanced features selected interactively by the user.

According to another aspect of the invention, there is provided a method of managing television programs and their related web simulcasts, the method comprising the steps of: detecting incoming television signals from a plurality of sources for tag information identifying the source of synchronized web simulcasts; establishing a communication channel to the source of the synchronized web simulcasts; retrieving a number of enhanced features from the source of the synchronized web simulcasts; storing the retrieved enhanced features in a storage medium for subsequent retrieval; and, formatting the retrieved, enhanced features according to predetermined criteria to generate a content list that is selectable by a user.

The foregoing and other features, and advantages of the invention will be apparent from the following, more detailed description of preferred embodiments as illustrated in the accompanying drawings in which reference characters refer to the same parts throughout the various views. The drawings are not necessarily to scale; the emphasis instead is placed upon illustrating the principles of the invention.

### DETAILED DESCRIPTION OF THE DRAWINGS

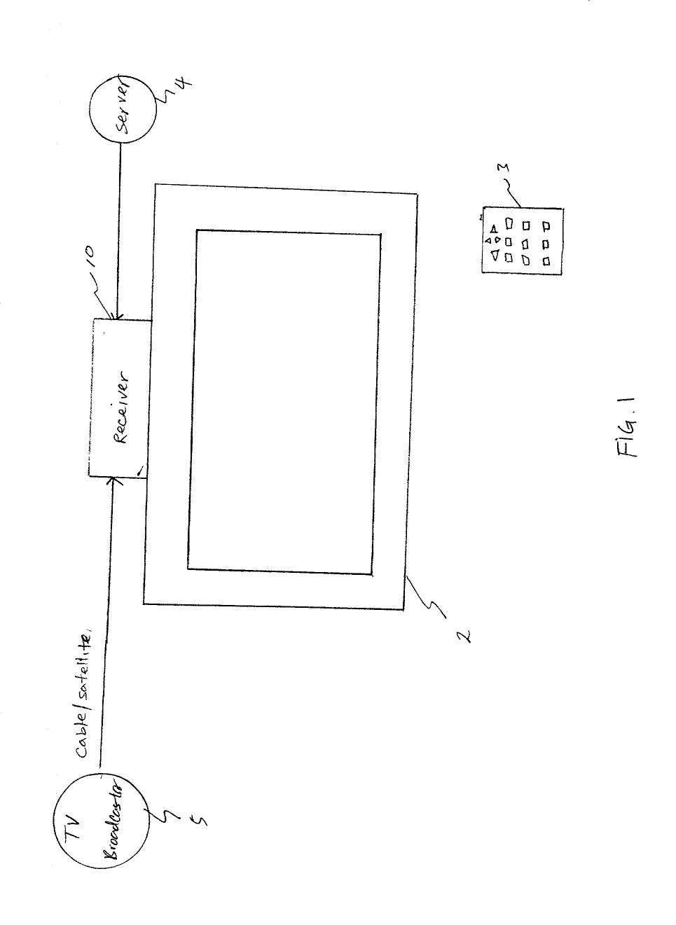

FIG. 1 is a simplified block diagram of the system capable of managing television programs and its related web simulcasts according an exemplary embodiment of the present invention;

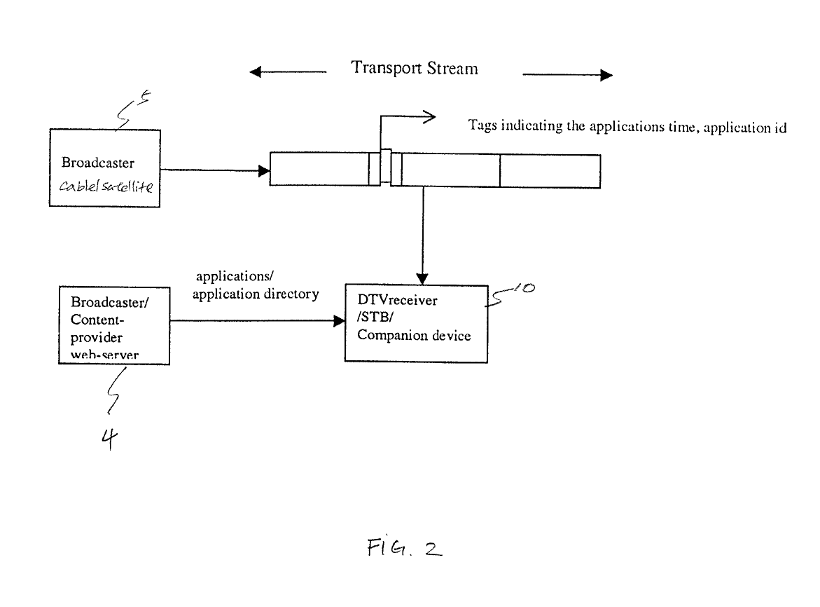

FIG. 2 is another simplified block diagram of the system capable of managing television programs and its related web simulcasts according an exemplary embodiment of the present invention;

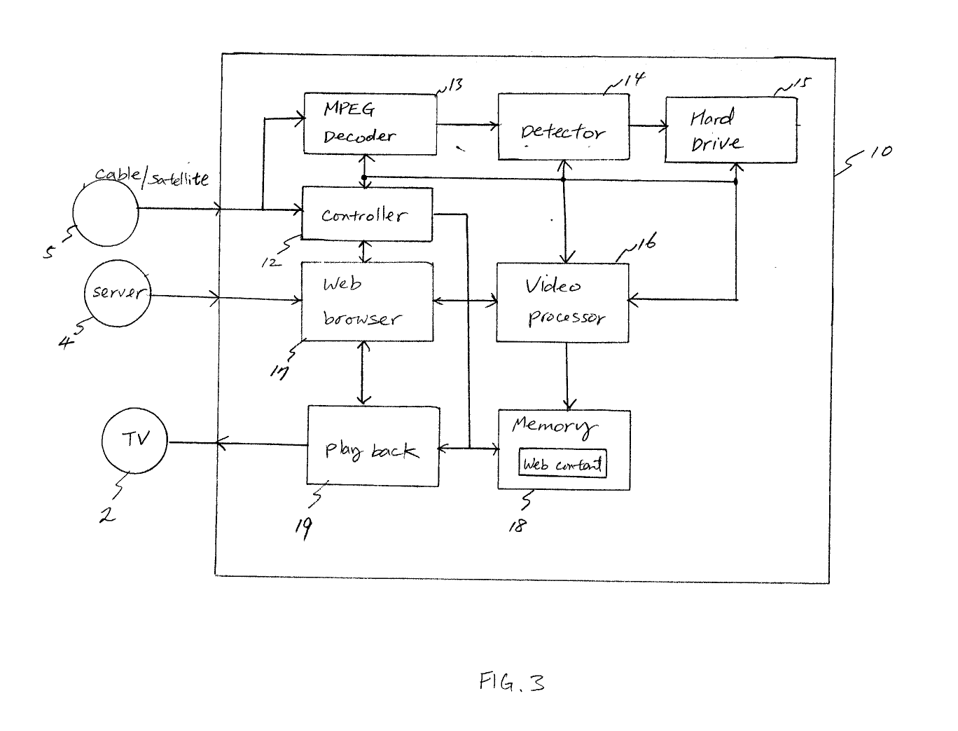

FIG. 3 is a simplified block diagram of the management system according to an embodiment of the present invention;

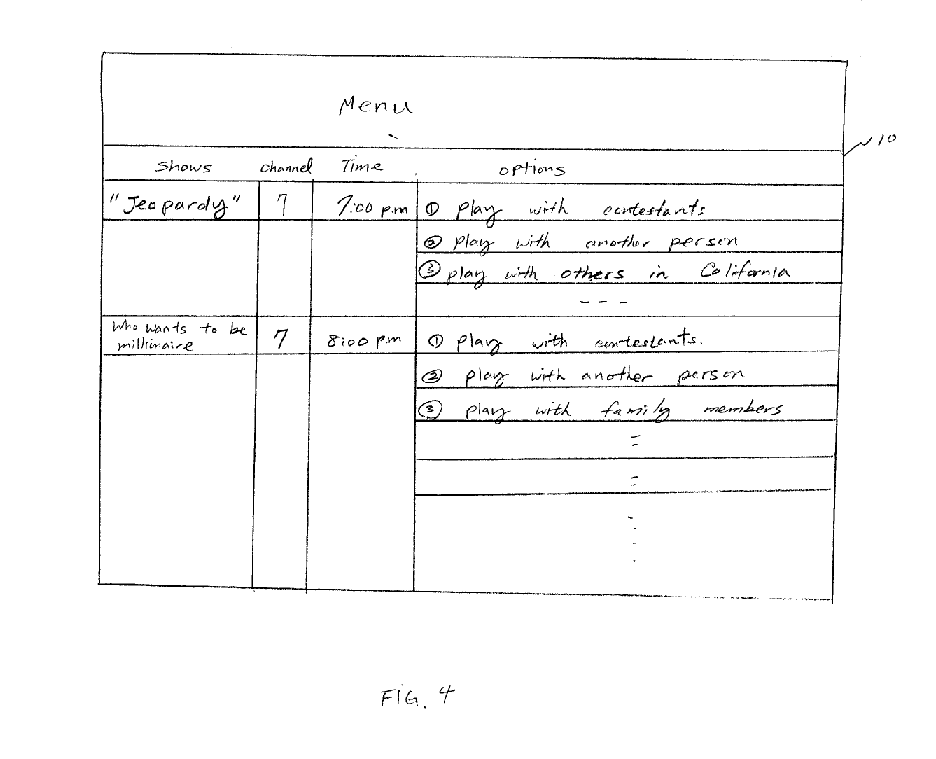

FIG. 4 is a representation of information managed by the system shown in FIG. 3 in accordance with the present invention; and,

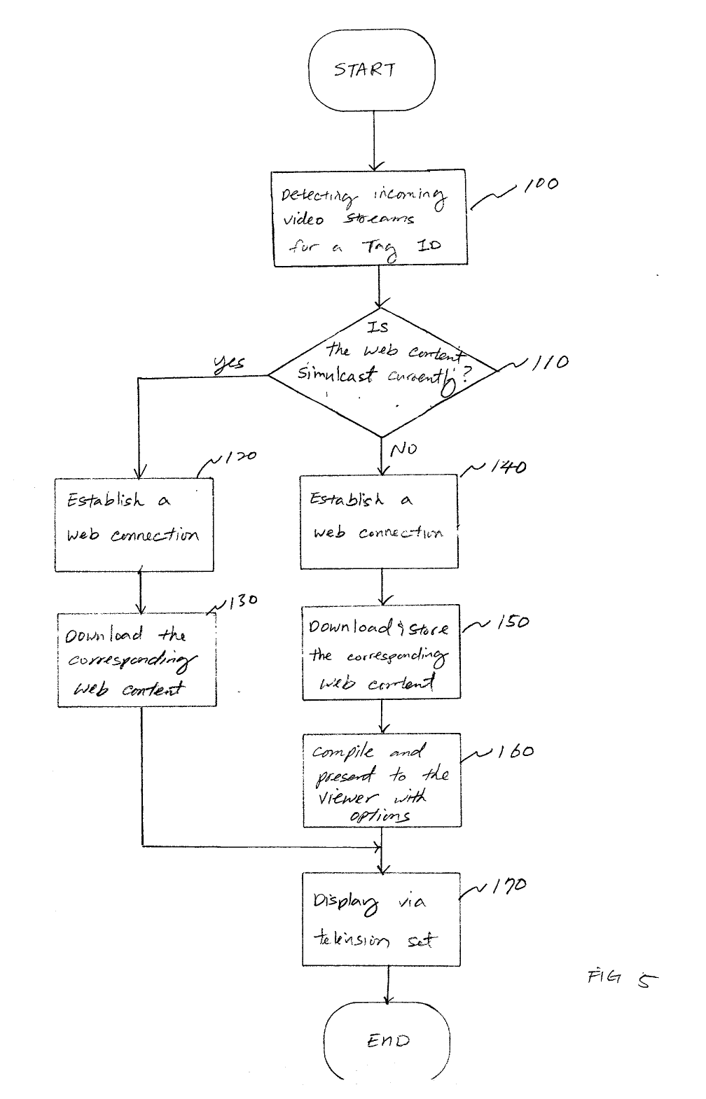

FIG. 5 is a flow chart illustrating the operation steps according to the present invention.

### DETAILED DESCRIPTION OF THE EMBODIMENTS

In the following description, for purposes of simplicity and clarity rather than limitation, detailed descriptions of well-known devices, circuits, and methods are omitted so as not to obscure the description of the present invention with unnecessary detail.

Referring to FIG. 1, a preferred embodiment of the present invention is a receiver system 10, which is capable of compiling and managing a plurality of web simulcasts synchronized to a number of television programs. The compiled information is presented to a viewer so that the viewer can selectively choose one of many “enhanced features” available in a particular television program. As shown in FIG. 1, the receiver system 10 is configured to receive audio/video programming and data signals from the conventional television (TV) broadcaster 5 and the Internet content provider (or server) 4. Both incoming signals are then forwarded to a television set 2 for display. The TV programs can be delivered in analog, digital, or digitally compressed formats via any transmission means, including satellite, wireless, cable, wire, and the Web. Alternatively, the receiver system 10 may be coupled to a personal computer system (not shown) to receive the Internet content from a particular web server via a high-speed line, RF, conventional modem, or a two-way cable carrying the video programming. A remote controller 3 is also provided to issue command signals to the inventive system 10 as occasion demands.

Referring to FIG. 2, the system 10 according to the principle of the present invention monitors the incoming TV program signals to detect tag information (ID), which indicates information relating to the synchronized play of a particular TV broadcast with the corresponding enhanced web content. The tag ID, which is inserted in the transport data by the broadcaster, will include the application time and the source of the web content provider (or application ID) from which the web content associated with the TV program is provided. The tag ID is designed to aid the receiver system 10 in the navigation of and selection from broadcast materials available in a digital TV environment. As such, the tag ID provides information about each program and includes programming characteristics, such as the web address of the corresponding enhanced TV web simulcast, program title, start time, end time, elapsed time, time remaining, and a brief description of the program's content.

Upon detecting the tag ID, the browser provided in the receiver system 10 is activated to establish a web connection to the web server 4 that is specified by the tag ID. The server 4 is typically a remote computer system that is accessible over the Internet. A user can link to the server 4 utilizing the functionality provided by a hypertext transfer protocol (HTTP). The World Wide Web (WWW) includes all servers adhering to this protocol, and these servers are accessible by users (or clients) via a Universal Resource Locator (URL). Hence, one can gain access to Internet services by specifying Universal Resource Locators that have two basic components: a protocol to be used and an object pathname. For example, the Universal Resource Locator address, “http://www.disney.com” specifies a hypertext transfer protocol (“http”) and a pathname of the server (“www.disney.com”). The server name is associated with a unique numeric value (TCP/IP address). The web connection can be also made to a proxy, or an unaffiliated third party providing the interactive capability. The function of a server 4 is present information in the form of HTTP responses (or web pages) in response to a user's request. As such, electronic information is presented to a user in hypertext in which text, images, sounds, and action are linked together in complex associations that permit the user to browse through related topics.

After establishing a communication channel to the web server 4 providing a number of “enhanced programs” to the public, the content of the web server 4 and its related application are downloaded in advance and stored in the receiver system 10. Meanwhile, all the downloaded information is reorganized and presented to the viewer in an easily recognizable format for subsequent retrieval during a play mode, so that the viewer will be aware of different types of enhanced features available for a given TV program. Thereafter, in the play mode, both “enhanced programs” tied to a particular TV program are played in a synchronized manner so that the user will be able to participate interactively. Alternatively the “enhanced features” may be retrieved automatically by the receiver system 10 and presented to the user at the time its associated TV program is broadcast.

FIG. 3 depicts a pictorial representation of the receiver system 10 in accordance with the exemplary embodiment shown in FIG. 1. The receiver system 10 includes a controller 12, MPEG decoder 13, a detector 14, a hard drive 15, video processor 16, memory 18, and play back section 19. It is noted that MPEG decoder 13 may comply with other MPEG standards, i.e., MPEG-1, MPEG-2, MPEG-4, and MPEG-7. The controller 12 overseas the overall operations of the system 10, including a view mode, record mode, play mode, and other modes that are common in the conventional set-top box.

In the operation mode, the receiver system 10 receives a stream of TV programs through a variety of mediums, including a cable service provider, a satellite dish, and a conventional RF broadcast. The controller 12 causes the MPEG decoder 13 to decode the incoming TV signals, then the decoded TV signals are monitored by the detector 14 for detecting the tag ID. The decoded TV signals are forwarded to the play back section 19 for display in the television set 2, or can be stored in the hard drive 15 for subsequent retrieval. If the tag ID is detected, the source of the relevant web content provider is determined. Then, the controller 12 causes the web browser 17 to make a connection to the corresponding web server 4. The web content, including all the application and the HTML format, are downloaded and saved in the memory 18 for subsequent retrieval. It is noted that any number of commercially or publicly available browsers can be utilized in various implementations in accordance with the preferred embodiment of the present invention. For example, a browser such as Netscape (a trademark of Netscape, Inc.) can be utilized in accordance with a preferred embodiment of the present invention to provide the functionality specified under HTTP. For example, the receiver system 10 detects a tag ID indicating that a particular TV program (i.e., “Who Wants To Be A Millionaire” from the ABCe™ television company) is simulcast with the web content from the same broadcaster's web server (i.e., www.ABC.com) at a specified time. The broadcaster's web server is scheduled to offer a number of different “enhanced features” in which a viewer can participate. Accordingly, the system 10 downloads the related web content and application information, so that a subsequent play of the TV program can be realized later along with the related web content from the broadcaster's server.

The above-described downloading operation is performed for a number of TV programs. The receiver system 10 processes this information that is downloaded from the respective broadcaster's web server and summarizes it in the format, listing different “enhanced features” provided by the respective TV broadcaster, as shown in FIG. 4. The downloaded web content is time stamped and synchronization points are added for subsequent replay purposes. Thereafter, the play back section 19 retrieves the stored web content from the memory 18 and re-synchronizes it back together with the corresponding TV program during a play mode. For example, the viewer is presented with a list shown in FIG. 4 to make a selection. For a given show, the viewer has several options to participate in different “enhanced features.” If the viewer wishes to play with the contestants of the show, “Jeopardy”, the viewer will select option 1. In this manner, a viewer watching the TV program at a later time can selectively pick and enjoy the “enhanced feature” offered by the broadcaster's server. Although a limited number of enhanced simulcasts is shown in FIG. 4 for illustrative purposes, it is to be understood that the present invention can support a much larger number of “enhanced features.” The number of different “enhanced features” in the drawing should not impose limitations on the scope of the invention.

FIG. 5 is a flow diagram illustrating the operation steps performed by the present invention. The chosen embodiment of the present invention is a software executing within the system 10. Computer programs (or computer control logic) are stored in the memory 18. Such computer programs, when executed, enable the computer system to perform the function of the present invention as discussed herein. The rectangular elements indicate computer software instruction, whereas the diamond-shaped element represents computer software instructions that affect the execution of the computer software instructions represented by the rectangular blocks. Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information that one of ordinary skill in the art requires to fabricate circuits or to generate computer software to perform the processing required of the particular apparatus.

Upon receiving the incoming TV signals from a cable service provider, antenna, or satellite service, the receiver system 10 detects the tag ID indicating the time and the source of the web content in step 100. The tag ID provides a particular web content that is to be synchronized with the incoming TV program. If the tag ID is detected from the incoming TV signals, the receiver system 10 determines whether the web content that requires to be synchronized with the TV program is simulcast currently, in step 110. If so, the system 10 establishes, in step 120, a web connection by activating the web browser 17 of the receiver system 10 automatically to the corresponding broadcaster's web server inferred from the detected tag ID for display. In step 130, the specified web content is downloaded from the broadcaster's web server and simulcast with the corresponding TV program in step 170. If the detected tag ID indicates that the web content related to the TV program is scheduled for a later time in step 110, the system 10 establishes a web connection 10 to the corresponding broadcaster's web server in step 140. Then, all events and application contents from the specified Web cast are stored in the memory 19 of the receiver system 10 in step 150. In step 160, the system 10 processes the downloaded web contents and generates a content list according to pre-specified criteria. During a normal play mode, the web content stored in the memory 18 of the system 10 is retrieved and re-synchronized with the TV program during the normal viewing time. At the same time, if the viewer wishes to participate in one of the “enhanced features” along with the simulcast Internet content, the system 10 presents an option window, as shown in FIG. 4, and causes the playback circuit 10 to display the selected enhancement feature along with the TV program.

Having thus described a preferred embodiment of a method and system for managing a number of enhancement features in a digital TV environment, it should be apparent to those skilled in the art that certain advantages of the system have been achieved. The foregoing is to be constructed as only being an illustrative embodiment of this invention. Persons skilled in the art can easily conceive of alternative arrangements providing a functionality that is similar to this embodiment without any deviation from the fundamental principles or the scope of this invention.

What is claimed is:

1. A method for managing television programs and their synchronized web simulcasts, the method comprising the steps of:
(a) detecting incoming television signals from a plurality of sources for tag information identifying the source of said synchronized web simulcasts;
(b) establishing a communication channel to the source of said synchronized web simulcasts;
(c) retrieving a number of enhanced features from the source of said synchronized web simulcasts;
(d) storing said retrieved enhanced features in a storage medium for subsequent retrieval; and,
(e) formatting said retrieved, enhanced features according to predetermined criteria to generate a content list.

2. The method of claim 1, further comprising the step of presenting said content list to a viewer.

3. The method of claim 1, wherein said content listing includes information selected from the group consisting of enhanced feature description, source, length, starting time, ending time, and a combination thereof.

4. The method of claim 1, further comprising the step of selecting one of said enhanced features tied to a TV program by a viewer.

5. The method of claim 4, further comprising the step of displaying one of said enhanced features selected by said user with the corresponding TV program that is synchronized to said selected enhanced feature.

6. The method of claim 1, wherein said predetermined criteria defines the number of enhanced features associated with the source of said synchronized web simulcasts.

7. The method of claim 1, wherein said plurality of sources includes at least one of a television network, Internet network, wireless network, and wired network, or a combination thereof.

8. A method for managing television programs and their synchronized web simulcasts, the method comprising the steps of:
(a) receiving a plurality of television programs from a plurality of television broadcasters;
(b) detecting the plurality of said television programs for tag information identifying the respective source of said synchronized web simulcasts;
(c) determining whether said detected tag information indicates that said synchronized web simulcasts are being broadcast currently; and,
(c)(1)(i) if yes, establishing a channel connection to the source of said synchronized web simulcasts indicated by said tag information;
(c)(1)(ii) downloading and displaying a number of enhanced features from the source of said synchronized web simulcasts to a viewer;
(c)(2)(i) if no, establishing a channel connection to the source of said synchronized web simulcasts indicated by said tag information; and,
(c)(2)(ii) downloading a number of enhanced features from the source of said synchronized web simulcasts for storage in a memory medium for subsequent retrieval; and,
(d) formatting said retrieved enhanced features according to predetermined criteria to generate a content list selectable by said viewer.

9. The method of claim 8, further comprising the step of presenting said content list to said viewer.

10. The method of claim 8, further comprising the step of selecting one of said enhanced features tied to a TV program by said viewer.

11. The method of claim 8, further comprising the step of displaying one of said enhanced features selected by said user with the corresponding TV program that is synchronized to said selected enhanced feature.

12. The method of claim 8, wherein said step of displaying is performed interactively in response to said viewer's input.

13. The method of claim 8, wherein said content listing includes information selected from the group consisting of an enhanced feature description, source, length, starting time, ending time, and a combination thereof.

14. The method of claim 8, wherein said predetermined criteria defines the >number of enhancement features associated with the source of said synchronized web simulcasts.

15. A system for managing television programs and their related web simulcasts, comprising:
a detection means, coupled to receive incoming television programs viewed by a user, for detecting tag information indicating the source of synchronized web simulcasts;
a communication means for establishing a communication channel to the source of said synchronized web simulcasts;
a storage means for storing data representative of a plurality of enhanced features corresponding to said incoming television programs;
a controlling means, coupled to said storage means, said detection means, and said communication means, for retrieving the plurality of said enhanced features from the source of said synchronized web simulcasts and for formatting said retrieved enhanced features according to predetermined criteria to generate a content list selectable by said user; and,
a display means, coupled to said controlling means, for displaying said incoming television programs and one of said retrieved enhanced features selected interactively by said user.

16. The system of claim 11, wherein the data representative of the plurality of said enhanced features is interactively created in advance.

17. The system of claim 15, wherein said predetermined criteria defines the number of enhancement features associated with the source of said synchronized web simulcasts.

18. The system of claim 15, wherein the data representative of the plurality of said enhanced features is interactively created in advance.

19. The system of claim 15, wherein said content listing includes information selected from the group consisting of an enhanced feature description, source, length, starting time, ending time, and a combination thereof.

20. A system for managing television programs and their related web simulcasts, comprising:
a memory for storing a computer-readable code; and,
a processor operatively coupled to said memory, said processor configured to:
detect incoming television signals from a plurality of sources for tag information identifying the source of synchronized web simulcasts;
establish a communication channel to the source of said synchronized web simulcasts;
retrieve a number of enhanced features from the source of said synchronized web simulcasts;
store said retrieved enhanced features in a storage medium for subsequent retrieval;
format said retrieved enhanced features according to predetermined criteria to generate a content list; and,
display one of said enhanced features selected by said user with the corresponding TV program that is synchronized to said selected enhanced feature.

21. The method of claim 20, wherein said content listing includes information selected from the group consisting of an enhanced feature description, source, length, starting time, ending time, and a combination thereof.

22. The system of claim 20, wherein said predetermined criteria defines the number of enhancement features associated with the source of said synchronized web simulcasts.
